(19) United States
(12) Patent Application Publication
(10) Pub. No.: US 2025/0231855 A1
(43) Pub. Date: Jul. 17, 2025

(54) Real-time Automation Bot

(71) Applicant: Concentrix Corporation, Fremont, CA (US)

(72) Inventors: Bhupesh Gajria, Gurgaon (IN); Devendra Malik, Bangalore (IN); Vishesh Nigam, Bangalore (IN); Amara V, Bangalore (IN); Kaushik Saha, Kolkata (IN); Debasish Roy Chowdhury, Kolkata (IN)

(21) Appl. No.: 18/854,100

(22) PCT Filed: Apr. 3, 2023
(86) PCT No.: PCT/US2023/017261

§ 371 Date: Oct. 4, 2024

(30) Foreign Application Priority Data
Apr. 4, 2022 (IN) 202211020307

(51) Int. Cl. G06F 11/34; G06F 11/30; H04L 12/18; H04L 67/50

(52) U.S. Cl. CPC G06F 11/3438; G06F 11/3072; H04L 12/1831; H04L 67/535

(57) ABSTRACT

Systems and methods for automated tracking and notification generation can include automatically collecting and analyzing communication session data from a plurality of remote users. The systems and methods can include a real-time automation bot that can obtain the data, analyze the data, generate a notification, and provide the notification for transmission. The real-time automation bot can enable one or more supervisors to supervise a plurality of remote users with relative ease.

### RELATED APPLICATIONS

This application claims priority to and the benefit of Indian Provisional Patent Application No. 202211020307, filed Apr. 4, 2022. Indian Provisional Patent Application No. 202211020307 is hereby incorporated by reference in its entirety.

### FIELD

The present disclosure relates generally to obtaining and analyzing communication session data. More particularly, the present disclosure relates to a real-time automation bot configured to obtain communication session data, determine a threshold has been met, and generate a notification based on the threshold being met.

### BACKGROUND

As technology enables increasing levels of remote working and global expansion, monitoring the agents' activity for meeting metrics can become increasingly more difficult. Work from home can cause additional hurdles for oversight. In an office environment, hands-on supervision can allow for more ease in the monitoring of communication sessions; however, remote working does not afford the same luxuries. Additionally, even in person work environments can provide opportunity for limited oversight capabilities for supervisors.

### SUMMARY

Aspects and advantages of embodiments of the present disclosure will be set forth in part in the following description, or can be learned from the description, or can be learned through practice of the embodiments.

One example aspect of the present disclosure is directed to a computing system for automated tracking of communication sessions for remote users. The computing system can include one or more processors and one or more non-transitory computer-readable media that collectively store instructions that, when executed by the one or more processors, cause the computing system to perform operations. The operations can include obtaining initial data. The initial data can be associated with a begin time of a communication session. In some implementations, the communication session can include a first user. The operations can include determining a threshold time has elapsed without receiving end data. The end data can be associated with an end time. The operations can include generating a first notification and a second notification based on the threshold time lapsing. In some implementations, the first notification can include one or more status indicators. The operations can include transmitting, via a network connection, the first notification to the first user and transmitting, via the network connection, the second notification to a second user. The operations can include generating session data. In some implementations, the session data can include information associated with the communication session. The operations can include storing the session data.

In some implementations, the operations can include obtaining second initial data. The second initial data can be associated with a second begin time associated with a second communication session. The second communication session can include a third user. The operations can include determining the threshold time has elapsed without receiving second end data. The second end data can be associated with a second end time associated with the second communication session. The second notification can include data associated with the communication session and the second communication session. In some implementations, the operations can include obtaining hold data. The hold data can be descriptive of a hold time associated with the first user. The operations can include determining the hold time is greater than a hold time threshold, generating a third notification and a fourth notification, transmitting via the network connection, the third notification to the first user, and transmitting, via the network connection, the fourth notification to the second user. The initial data and the end data can be obtained from a remote desktop. The one or more status indicators can be descriptive of a threshold status for the communication session.

Another example aspect of the present disclosure is directed to a computer-implemented method for real-time tracking and notification transmission. The method can include obtaining, via a management console application programming interface and by a computing system including one or more processors, communication session data from a remote computing device. The method can include generating, by the computing system, a first notification. The first notification can be descriptive of at least a portion of the communication session data. The method can include providing, via an agent user interface and by the computing system, the first notification to a first user. The method can include determining, by the computing system, the communication session data includes time data associated with a threshold time being met. The method can include generating, by the computing system, a second notification based on the threshold time being met. In some implementations, the second notification can include session information. The session information can include first user data and at least a portion of the communication session data. The first user data can be associated with the first user. The method can include providing, via a supervisor user interface and by the computing system, the second notification to a second user.

In some implementations, the first user and the second user can be in different locations. The remote computing device can be associated with the first user. In some implementations, the communication session data can include an elapsed communication time descriptive of overall length of time of a communication session, a hold time descriptive of overall length of time of a third user being put on hold, and a wait time descriptive of overall length of time of a fourth user being put on hold.

Another example aspect of the present disclosure is directed to a computing system. The computing system can include one or more processors, a real-time automation bot, and one or more non-transitory computer-readable media that collectively store instructions that, when executed by the one or more processors, cause the computing system to perform operations. The real-time automation bot can be configured to continuously and automatically obtain time data associated with one or more communication events, and the real-time automation bot can be configured to generate one or more notifications based on the time data. The operations can include obtaining, via the real-time automation bot, a plurality of user communication datasets. In some implementations, the plurality of user communication datasets can be associated with a plurality of respective remote users. The operations can include determining, via the real-time automation bot, a plurality of statuses based on one or more thresholds. The plurality of statuses can be associated with the plurality of user communication datasets. The operations can include determining, via the real-time automation bot, one or more particular statuses of the plurality of statuses that are indicative of a particular performance status. In some implementations, the operations can include generating, via the real-time automation bot, a notification based on the one or more particular statuses. The operations can include providing, via a user interface, the notification.

In some implementations, the particular performance status can include a poor performance status as determined by comparing an elapsed time associated with a respective user communication dataset. The notification can be descriptive of one or more particular user communication datasets. The one or more particular user communication datasets can be associated with the one or more particular statuses. Providing, via the user interface, the notification can include generating a pop-up interface element descriptive of the notification and providing the pop-up interface element in the user interface.

In some implementations, providing, via the user interface, the notification can include generating a supervisor report descriptive of the notification and providing the supervisor report in the user interface. Obtaining, via the real-time automation bot, the plurality of user communication datasets can include accessing, via the real-time automation bot, a remote desktop; identifying, via the real-time automation bot, data for collection; and obtaining, via the real-time automation bot, the data for collection. Obtaining, via the real-time automation bot, the plurality of user communication datasets further can include deleting, via the real-time automation bot, the data for collection from the remote desktop in response to obtaining the data for collection.

In some implementations, the operations can include obtaining a plurality of user specific datasets associated with the plurality of respective remote users. The notification can be generated based at least in part on one or more particular user specific datasets of the plurality of user specific datasets. The one or more particular user specific datasets can be associated with the one or more particular statuses. In some implementations, the operations can include determining, via the real-time automation bot, a user trigger event occurred based at least in part on the plurality of user specific datasets; generating, via the real-time automation bot, an additional notification based on the user trigger event; and providing, via the user interface, the additional notification. The user trigger event can include one or more remote users of the plurality of respective remote users logging out of a remote user interface before a preset time.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system that performs automated tracking and notification generation according to example embodiments of the present disclosure.

FIG. 2 depicts a block diagram of an example bot architecture according to example embodiments of the present disclosure.

FIG. 3 depicts an illustration of an example metrics dashboard according to example embodiments of the present disclosure.

FIG. 4 depicts an illustration of an example metrics dashboard according to example embodiments of the present disclosure.

FIGS. 5A-5B depict illustrations of example notifications according to example embodiments of the present disclosure.

FIG. 6 depicts a flow chart diagram of an example method to perform communication session data tracking according to example embodiments of the present disclosure.

FIG. 7 depicts a flow chart diagram of an example method to perform communication session data tracking according to example embodiments of the present disclosure.

FIG. 8 depicts a flow chart diagram of an example method to perform communication session data tracking according to example embodiments of the present disclosure.

Reference numerals that are repeated across plural figures are intended to identify the same features in various implementations.

### DETAILED DESCRIPTION

### Overview

Generally, the present disclosure is directed to systems and methods for utilizing one or more real-time automation bots to track communication sessions and generate notifications in response to one or more thresholds being met. In particular, the systems and methods can leverage the one or more real-time automation bots to quickly and efficiently large quantities of data for a plurality of remote users. Such systems and methods can help solve supervisory issues caused by the increased shift to work at home systems. For example, the systems and methods disclosed herein can include obtaining initial data. The initial data can be associated with a begin time of a communication session. In some implementations, the communication session can include a first user. The systems and methods can include determining a threshold time has elapsed without receiving end data. The end data can be associated with an end time. A first notification and a second notification can be generated based on the threshold time lapsing. In some implementations, the first notification can include one or more status indicators. The first notification can be transmitted to the first user via a network connection. The second notification can be transmitted to the second user via the network connection. Additionally and/or alternatively, the systems and methods can generate session data. The session data can include information associated with the communication session. The session data can then be stored.

The systems and methods can obtain initial data. The initial data can be associated with a begin time of a communication session. The communication session can include a first user. The first user can be an agent facilitating one or more communication sessions. The communication sessions can include a phone call, a video call, chat via a user interface, etc.

Additionally and/or alternatively, the systems and methods can determine a threshold time has elapsed without receiving end data. The end data can be associated with an end time. In some implementations, the initial data and the end data can be obtained from a remote desktop. For example, a remote desktop can aggregate communication session data from one or more communication services providers. The remote desktop can then be accessed by a server computing system.

A first notification and a second notification can be generated based on the threshold time lapsing. In some implementations, the first notification can include one or more status indicators. The one or more status indicators can be descriptive of a threshold status for the communication session. The one or more status indicators can include a color indicator (e.g., a green indicator may be descriptive of the communication session being below a threshold time and a red indicator may be descriptive of the communication session elapsing the threshold time).

The first notification can be transmitted to the first user. The transmission can occur via a network. In some implementations, the first notification may be provided in an agent user interface. The first notification may be provided as a pop-up display and can include the elapsed time for the communication session.

The second notification can be transmitted to a second user. The second user can be a supervisor for the agent. The supervisor can be located in a different location than the first user. In some implementations, the first user and the second user may be communicatively connected via an internet connection. The transmission can occur via the network. In some implementations, the second notification may be provided in a supervisor user interface. The second notification may be provided as a pop-up display and can include the elapsed time for the communication session. The second notification can be provided in a report that lists data associated with a plurality of first users in a plurality of communication sessions.

The systems and methods can generate session data. The session data can include information associated with the communication session. In some implementations, the session data can be descriptive of the begin time and the end time of the talk time, the hold time, the wait time, and/or the wrap time.

The session data can be stored. In some implementations, the session data can be stored in a database for retrieval for future reports, for additional metric generation, or for determining new thresholds.

In some implementations, the systems and methods can include obtaining second initial data. The second initial data can be associated with a second begin time associated with a second communication session. The second communication session can include a third user. The third user can be a second agent under the supervision of the second user. The systems and methods can include determining the threshold time has elapsed without receiving second end data. The second end data can be associated with a second end time associated with the second communication session. The second notification can include data associated with the communication session and the second communication session.

Alternatively and/or additionally, the systems and methods can obtain hold data. The hold data can be descriptive of a hold time associated with the first user. The hold time can be processed to determine the hold time is greater than a hold time threshold. A third notification and a fourth notification can be generated in response to the determination. The third notification can be provided to the first user (e.g., via the agent user interface), and the fourth notification can be provided to the second user (e.g., via the supervisor user interface).

Alternatively and/or additionally, the systems and methods can include obtaining, via a management console application programming interface, communication session data from a remote computing device. A first notification can be generated based on the communication session data. In some implementations, the first notification can be descriptive of at least a portion of the communication session data. The systems and methods can provide, via an agent user interface, the first notification to a first user. Additionally and/or alternatively, the systems and methods can determine the communication session data includes time data associated with a threshold time being met. A second notification can be generated based on the threshold time being met. In some implementations, the second notification can include session information. The session information can include first user data and at least a portion of the communication session data. The first user data can be associated with the first user. The systems and methods can provide, via a supervisor user interface, the second notification to a second user.

In some implementations, a management console application programming interface can be utilized to obtain communication session data from a remote computing device. The remote computing device can be associated with the first user. The remote computing device can be communicatively connected to a phone device.

The communication session data can include an elapsed communication time descriptive of overall length of time of a communication session, a hold time descriptive of overall length of time of a third user being put on hold, and a wait time descriptive of overall length of time of a fourth user being put on hold. In some implementations, the third user and the fourth user can be the same person. Alternatively and/or additionally, the third user and the fourth user can be different people.

A first notification can then be generated based on the communication session data. The first notification can be descriptive of at least a portion of the communication session data. The first notification can include the overall length of time, the hold time, and/or the wait time.

The first notification can be provided to a first user via an agent user interface. The first notification can be provided via a pop-up graphical element in the agent user interface. Alternatively and/or additionally, the first notification may be provided via a widget and/or gadget in the agent user interface.

Additionally and/or alternatively, the systems and methods can determine the communication session data includes time data associated with a threshold time being met. The threshold time can be set manually or via automatic determination (e.g., the threshold time can be determined based at least in part on aggregated data from a plurality of past communication sessions). For example, in some implementations, the standard deviation for communication session times can be determined. The standard deviation can then be utilized to determine an appropriate threshold time for flagging irregular events.

A second notification can then be generated based on the threshold time being met. The second notification can include session information. The session information can include first user data and at least a portion of the communication session data. In some implementations, the first user data can be associated with the first user.

The second notification can be provided to a second user via a supervisor user interface. In some implementations, the first user and the second user can be in different locations. For example, the first user can be an agent that is remotely working, and the second user can be a supervisor located in their own respective remote location.

In some implementations, the systems and methods disclosed herein can include a real-time automation bot. The real-time automation bot can be configured to continuously and automatically obtain time data associated with one or more communication events. In some implementations, the real-time automation bot can be configured to generate one or more notifications based on the time data. The real-time automation bot can be utilized to obtain a plurality of user communication datasets. The plurality of user communication datasets can be associated with a plurality of respective remote users. The systems and methods can determine, via the real-time automation bot, a plurality of statuses based on one or more thresholds. The plurality of statuses can be associated with the plurality of user communication datasets. Additionally and/or alternatively, the systems and methods can determine, via the real-time automation bot, one or more particular statuses of the plurality of statuses that are indicative of a particular performance status. The systems and methods can include generating, via the real-time automation bot, a notification based on the one or more particular statuses. The notification can be provided via a user interface.

The systems and methods disclosed herein can include a real-time automation bot. The real-time automation bot can be configured to continuously and automatically obtain time data associated with one or more communication events. In some implementations, the real-time automation bot can be configured to generate one or more notifications based on the time data. Additionally and/or alternatively, the real-time automation bot can include three sub-blocks: a console bot, an agent bot, and a supervisor bot.

In some implementations, the systems and methods can include obtaining, via the real-time automation bot, a plurality of user communication datasets. The plurality of user communication datasets can be associated with a plurality of respective remote users. Additionally and/or alternatively, the plurality of user communication datasets can be associated with a plurality of respective communication sessions.

Obtaining, via the real-time automation bot, the plurality of user communication datasets can include accessing a remote desktop, identifying data for collection, and obtaining the data for collection. In some implementations, in response to obtaining the data for collection, the real-time automation bot can delete the data for collection from the remote desktop.

The systems and methods can determine, via the real-time automation bot, a plurality of statuses based on one or more thresholds. The plurality of statuses can be associated with the plurality of user communication datasets. In some implementations, each status can be associated with a different respective communication session.

Additionally and/or alternatively, the systems and methods can include determining, via the real-time automation bot, one or more particular statuses of the plurality of statuses that are indicative of a particular performance status. The particular performance status can include a poor performance status as determined by comparing an elapsed time associated with a respective user communication dataset.

A notification can then be generated based on the one or more particular statuses. The notification can be descriptive of one or more particular user communication datasets. Additionally and/or alternatively, the one or more particular user communication datasets can be associated with the one or more particular statuses.

The notification can be provided via a user interface. For example, the systems and methods can generate a pop-up interface element descriptive of the notification and can provide the pop-up interface element in the user interface. Alternatively and/or additionally, the systems and methods can generate a supervisor report descriptive of the notification and can provide the supervisor report in the user interface.

In some implementations, the systems and methods can include obtaining a plurality of user specific datasets associated with the plurality of respective remote users. The notification can be generated based at least in part on one or more particular user specific datasets of the plurality of user specific datasets. In some implementations, the one or more particular user specific datasets can be associated with the one or more particular statuses.

Additionally and/or alternatively, the systems and methods can include determining, via the real-time automation bot, a user trigger event occurred based at least in part on the plurality of user specific datasets. The systems and methods can then generate, via the real-time automation bot, an additional notification based on the user trigger event. The additional notification can be provided via the user interface. In some implementations, the user trigger event can include one or more remote users of the plurality of remote users logging out of a remote user interface before a preset time.

In some implementations, the communication session data can include talk time data, hold time data, and wrap time data. Talk time data can be descriptive of the time during a call in which the first user and a third party are connected and not on hold. Hold time data can be descriptive of the time the first user and the third party are connected but the third party is put on hold. Wrap time data can be descriptive of the time after the call occurred in which the first user is inserting notes associated with the call and the particular third party user. In some implementations, the talk time, the hold time, and the wrap time may be utilized to calculate one or more efficiency metrics. The efficiency metrics can then be graphed to provide a graphical representation of the efficiency of the respective agents or the efficiency of the group of agents as a whole.

In some implementations, the notifications generated and provided by the systems and methods disclosed herein can be snoozed or hidden in response to a selection of a graphical element by a user. The snooze can temporarily hide or minimize the notification until a new event occurs or until a certain amount of time has elapsed.

Additionally and/or alternatively, new data can be fetched every five seconds to further update the notifications. Alternatively and/or additionally, the data may be collected at other frequencies.

In some implementations, the notification to the second user (e.g., the notification to the supervisor) may only occur when the system determines the first user needs help. The determination can be based on one or more thresholds that can be set by a first user, a second user, and/or may be set by automated processing that sets a threshold for outlier events.

Additionally and/or alternatively, the systems and methods disclosed herein can be utilized to monitor the work times of a plurality of remote users. For example, the systems and methods can obtain data indicative of time-in and time-outs of users. The data can then be processed to determine whether the respective user clocked-in on time and whether the respective user clocked-out on time. In response to a user clocking-in late or clocking-out early, a notification can be generated and provided to the supervisor.

The systems and methods can include a management module, an agent module, and a supervisor module. The management module can include secure shell (SSH) connectivity, a module for data extraction, and a module for data upload. The secure shell (SSH) connectivity can include a communication protocol between a computing device and a communication server system. The module for data extraction and/or the module for data upload can include a console bot that is configured to obtain the data, process the data, generate output data, and provide instructions for transmitting the output data. The agent module can include a module for pop-up generator. In some implementations, the agent module can include an agent bot for obtaining incoming data and providing a pop-up notification via an agent user interface. The supervisor module can include a module for pop-up generator. In some implementations, the supervisor module can include a supervisor bot for obtaining incoming data and providing a pop-up notification via a supervisor user interface.

The systems and methods of the present disclosure provide a number of technical effects and benefits. As one example, the system and methods can provide systems and methods for obtaining a plurality of datasets associated with a plurality of different communications sessions. The plurality of datasets can be processed to determine a status for the plurality of communications sessions. The statuses can then be utilized to generate reports and notifications to be sent to one or more users.

Another technical benefit of the systems and methods of the present disclosure is the ability to leverage one or more bots to automatically track actions of remote users to be utilized for remote supervision. For example, the systems and methods can track remote user actions and determine if one or more thresholds are met using one or more real-time automation bots.

Another example of technical effect and benefit relates to improved computational efficiency and improvements in the functioning of a computing system. For example, the systems and methods disclosed herein can leverage one or more real-time automation bots to facilitate the collection and analysis of data from a plurality of users. Additionally and/or alternatively, the real-time automation bot can facilitate the deletion of data from a server computing system post processing. The automated processing then deletion can allow for the freeing up of storage to be replaced by new data.

With reference now to the Figures, example embodiments of the present disclosure will be discussed in further detail.

### Example Devices and Systems

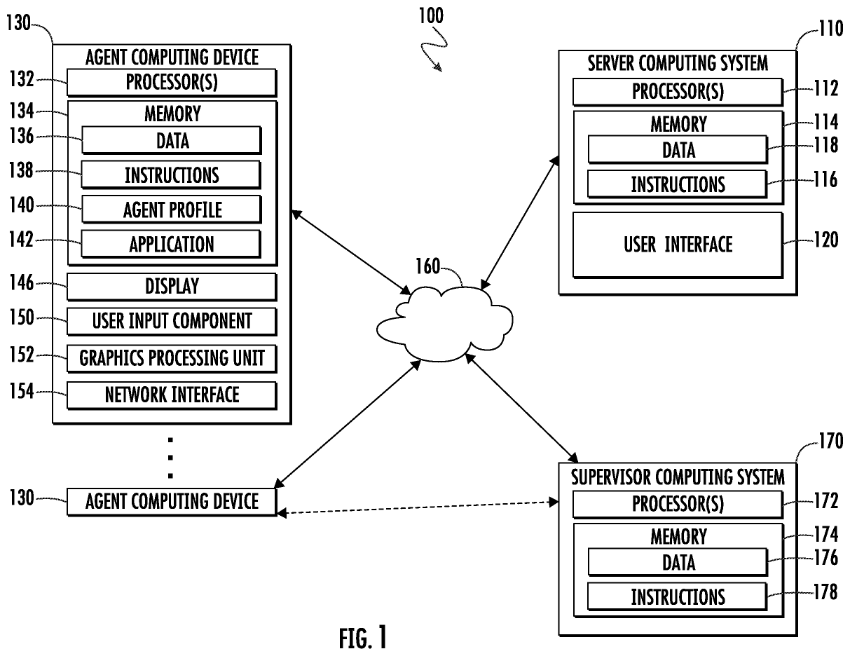

FIG. 1 depicts an exemplary computing system 100 that can be used to implement a real-time automation bot according to aspects of the present disclosure. The system 100 has an agent-supervisor-server architecture that includes a server 110 that communicates with one or more agent computing devices 130 over a network 160. However, the present disclosure can be implemented using other suitable architectures. The system 100 can also have a supervisor computing system 170 to receive and provide a notification in response to processing the communication session data using the computing system 100.

The system 100 includes a server 110, such as, for example, a web server. The server 110 can be one or more computing devices that are implemented as a parallel or distributed computing system. In particular, multiple computing devices can act together as a single server 110. The server 110 can have one or more processor(s) 112 and a memory 114. The server 110 can also include a network interface used to communicate with one or more remote computing devices (e.g., agent computing devices) 130 over a network 160.

The processor(s) 112 can be any suitable processing device, such as a microprocessor, microcontroller, integrated circuit, or other suitable processing device. The memory 114 can include any suitable computing system or media, including, but not limited to, non-transitory computer-readable media, RAM, ROM, hard drives, flash drives, or other memory devices. The memory 114 can store information accessible by processor(s) 112, including instructions 116 that can be executed by processor(s) 112. The instructions 116 can be any set of instructions that when executed by the processor(s) 112, cause the processor(s) 112 to provide desired functionality.

In particular, the instructions 116 can be executed by the processor(s) 112 to implement a user interface 120. The user interface 120 can be configured to provide an interface for an agent and/or a supervisor to interact with a server platform with metric reports and profiles. In some implementations, the user interface 120 can be configured to provide instructions to a supervisor computing system 170 to perform a notification service (e.g., instructions to generate and/or provide a notification based on communication session data). In particular, in some implementations, the user interface 120 can be provided for interaction with a user using an agent computing system 130 that communicates with the server computing system 110 via a network 160.

It will be appreciated that the term “element” can refer to computer logic utilized to provide desired functionality. Thus, any element, function, and/or instructions can be implemented in hardware, application specific circuits, firmware and/or software controlling a general purpose processor. In one implementation, the elements or functions are program code files stored on the storage device, loaded into memory and executed by a processor or can be provided from computer program products, for example computer executable instructions, that are stored in a tangible computer-readable storage medium such as RAM, hard disk or optical or magnetic media.

Memory 114 can also include communication session data 118 that can be retrieved, manipulated, created, or stored by processor(s) 112. Communication session data 118 can include a time data (e.g., a talk time, a hold time, and/or wrap time). As an example, communication session data 118 can be used to determine whether a notification should be generated and provided.

The communication session data 118 can be stored in one or more databases. The one or more databases can be connected to the server 110 by a high bandwidth LAN or WAN, or can also be connected to server 110 through a network 160. The one or more databases can be split up so that they are located in multiple locales.

The server 110 can exchange data with one or more agent computing devices 130 over the network 160. Although two agents 130 are illustrated in FIG. 1, any number of agent computing devices 130 can be connected to the server 110 over the network 160. The agent computing devices 130 can be any suitable type of computing device, such as a general purpose computer, special purpose computer, navigational device, laptop, desktop, integrated circuit, mobile device, smartphone, tablet, wearable-computing devices, a display with one or more processors coupled thereto and/or embedded therein, or other suitable computing device. Further, an agent computing device 130 can be multiple computing devices acting together to perform operations or computing actions.

Similar to server 110, an agent computing device 130 can include a processor(s) 132 and a memory 134. The memory 134 can store information accessible by processor(s) 132, including instructions that can be executed by processor(s) and data. As an example, memory 134 can store an agent profile element 140 and an application element 142.

Agent profile element 140 can provide instructions for implementing an agent profile. In particular, the user of agent computing device 130 can exchange data with server 110 by using the stored agent profile to auto-populate agent information in an interface or interaction. The user interface of the present disclosure can be provided as an element of an agent user interface of the application disclosed herein.

Application element 142 can provide instructions for running a specialized application on agent computing device 130. In particular, the specialized application can be used to exchange data with server 110 over the network 160 or provide a notification to the agent. Application element 142 can include client-device-readable code for providing and implementing aspects of the present disclosure. For example, application element 142 can provide instructions for implementing a pop-up graphical element descriptive of the notification.

Although FIG. 1 depicts the agent profile element 140 and the application element 142 being stored in the memory 134 of the computing device, in some implementations, the agent profile element 140 and/or the application element 142 may be stored in the memory 114 of the server computing system 110. Additionally and/or alternatively, the server computing system 110 can include a cloud computing system.

The agent computing device 130 can include various user input devices 150, or input components, for receiving information from a user, such as a touch screen, touch pad, data entry keys, speakers, mouse, motion sensor, and/or a microphone suitable for voice recognition. In some implementations, the server computing system 110 and the supervisor computing system 170 can include their own input components or may share one or more input components with the agent computing device 130, such that a user may be able to provide input for the supervisor computing system 170 using the input devices 150 of the agent computing device. Further, the agent computing device 130 can have a display 146 for presenting information, such as providing a user interface for receiving notifications and displaying communication session data. The display 146 can be a visual display including a plurality of visual components for providing the graphical elements of the plate third party interface to a user. The visual display can include a liquid crystal display (LCD), a light-emitting diode display (LED), a plasma display, an organic light-emitting diode display (OLED), and/or a cathode ray tube display (CRT).

The agent computing device 130 can further include a graphics processing unit 152. Graphics processing unit 152 can be used by processor 132 to provide an agent user interface. In some embodiments, agent computing device 130 and/or the server computing system 110 can be communicatively connected to provide the agent user interface.

The agent computing device 130 can include a network interface 154 for communicating with server 110 over network 160. Network interface 154 can include any components or configuration suitable for communication with server 110 over network 160, including, for example, one or more ports, transmitters, wireless cards, controllers, physical layer components, or other items for communication according to any currently known or future developed communications protocol or technology.

The network 160 can be any type of communications network, such as a local area network (e.g., intranet), wide area network (e.g., Internet), or some combination thereof. The network 160 can also include a direct connection between an agent computing device 130 and the server 110. In general, communication between the server 110 and an agent computing device 130 can be carried via network interface using any type of wired and/or wireless connection, using a variety of communication protocols (e.g., TCP/IP, HTTP), encodings or formats (e.g., HTML, XML), and/or protection schemes (e.g., VPN, secure HTTP, SSL).

In some implementations, the network 160 can be used to transfer communication between the server computing system 110 to the supervisor computing system 170 and/or the agent computing device 130. The communications can be instructions 138 generated in response to processing communication session data associated with an agent. For example, the agent computing device 130 may receive data descriptive of a notification from the server computing system 110. Instructions 116 can also be generated that can be interpreted by the supervisor computing system 170 to generate and/or provide a notification. Moreover, in some implementations, the instructions 118 can be processed by the one or more processors 172 of the supervisor computing system 170 in order to understand the instructions. The instructions can be saved to memory or interpreted into a more native format for the supervisor user interface. The supervisor computing system can further include memory components 174 for locally storing data 176 and instructions 178. The stored data 176 can include data specific to the supervisor and/or one or more agents being supervised including agent metrics, communication session reports, and/or aggregate metrics. In some implementations, the stored data 176 can include past instructions, information necessary for interpretation, and/or localized models. The stored instructions 178 can include predetermined functions, user-generated functions, and/or trained functions for various tasks the supervisor computing system can complete. For example, the stored instructions 178 can include a plurality of instructions for processing incoming data to generate and/or provide reports and/or notifications based on the communication session data.

In some implementations, one or more non-transitory computer readable media that collectively store instructions that, when executed by the one or more processors, cause the supervisor computing system to perform operations can be included in the computing system. In some implementations, the memory components of the agent computing device 130, the server computing system 110, and the supervisor computing system 170 can include the one or more non-transitory computer readable media. The stored instructions can include instructions that cause one or more of the computing systems to perform operations that can include the methods and processes disclosed herein.

In some implementations, one or more of the computing systems can leverage one or more application programming interfaces for automating application interactions. For example, in some implementations, the server computing system 110 may generate and/or store one or more application programming interfaces to facilitate communications with one or more supervisor computing system 170 applications. Moreover, in some implementations, the one or more application programming interface may be generated in response to one or more user interactions via the user interface 120 and/or the network interface 154.

### Example Model Arrangements

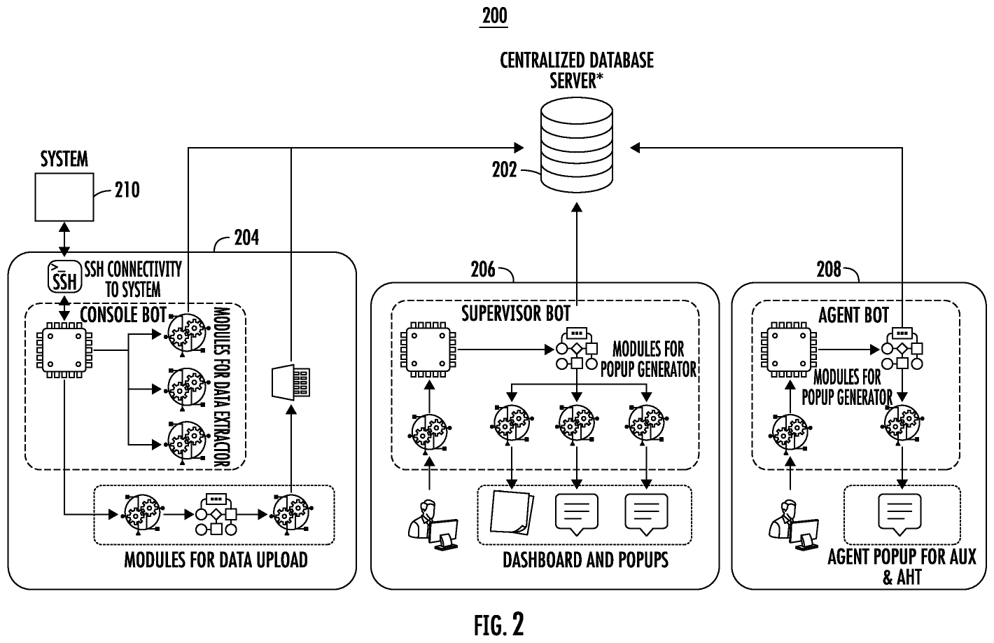

FIG. 2 depicts a block diagram of an example bot architecture 200 according to example embodiments of the present disclosure. In some implementations, the bot architecture 200 is configured to receive a set of input data descriptive of a communication session from a communication server system 210 via SSH connectivity and, as a result of receipt of the input data, provide output data that includes one or more notifications. Thus, in some implementations, the bot architecture 200 can include a management block 204 that is operable to obtain and analyze the communication session data, an agent block 208 that is operable to generate and/or provide a notification to the agent, and a supervisor block 206 that is operable to generate and/or provide a notification to the supervisor.

In particular, the example bot architecture 200 can include a management block 204 that includes a module for data extractor and a module for data upload. Additionally and/or alternatively, the management block 204 can include a console bot configured to obtain communication session data from a communication server system 210 via the SSH connectivity. The console bot can then facilitate the processing of the communication session data to determine if a threshold time has elapsed. The obtained data and the generated data can be transmitted to a centralized database server 202. The obtained data and/or the generated data can then be transmitted to the supervisor block 206 and the agent block 208.

The supervisor block 206 can include a module for popup generator and a supervisor bot. The supervisor bot can be configured to obtain the data associated with the determined trigger event in order to generate a pop-up notification descriptive of the communication session. The pop-up notification can be provided in a user interface dashboard and/or in a separate window.

The agent block 208 can include a module for popup generator and an agent bot. The agent bot can be configured to obtain the data associated with the determined trigger event in order to generate a pop-up notification descriptive of the communication session. The pop-up notification can be provided in a user interface dashboard and/or in a separate window.

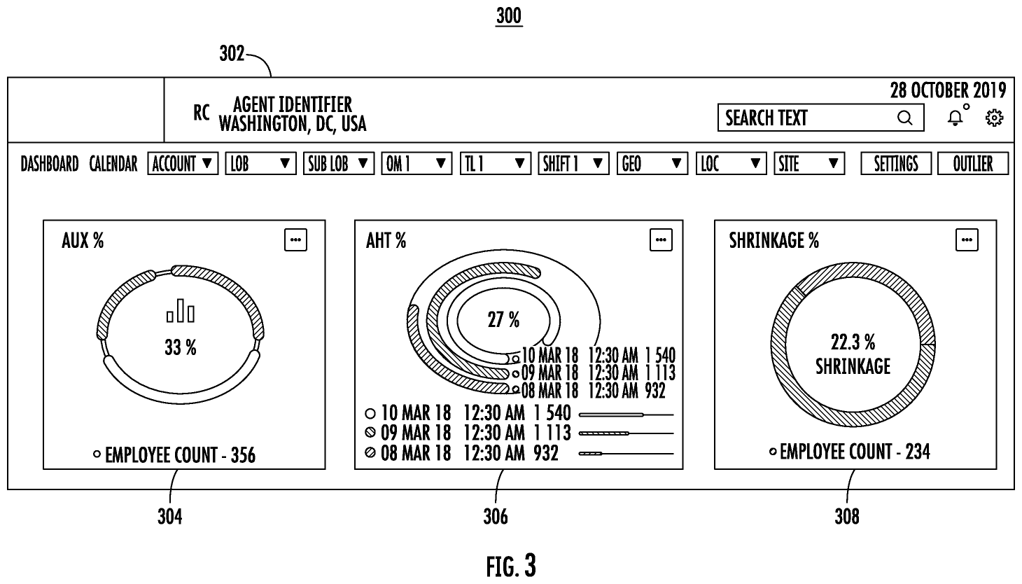

FIG. 3 depicts an illustration of an example metrics dashboard 300 according to example embodiments of the present disclosure. In particular, FIG. 3 can depict an example metrics dashboard 300 descriptive of three different metrics 304, 306, & 308. The metrics dashboard 300 can include a profile identifier 302 which may be fixed for the agent and may be selectable from a drop-down menu for supervisors. The metrics can be provided with a variety of representations. For example, the auxiliary data metrics 304 can be provided with a percentage of overall time along with a representation of the percentage makeup. The average hunter data metrics 306 (e.g., a time associated with the talk time, the hold time, and the wrap time) can be provided with multiple progress bars associated with different days along with relative percentages. Additionally and/or alternatively, other metrics 308 (e.g., shrinkage percentage) may be similarly provided with a numerical value and a graphical representation.

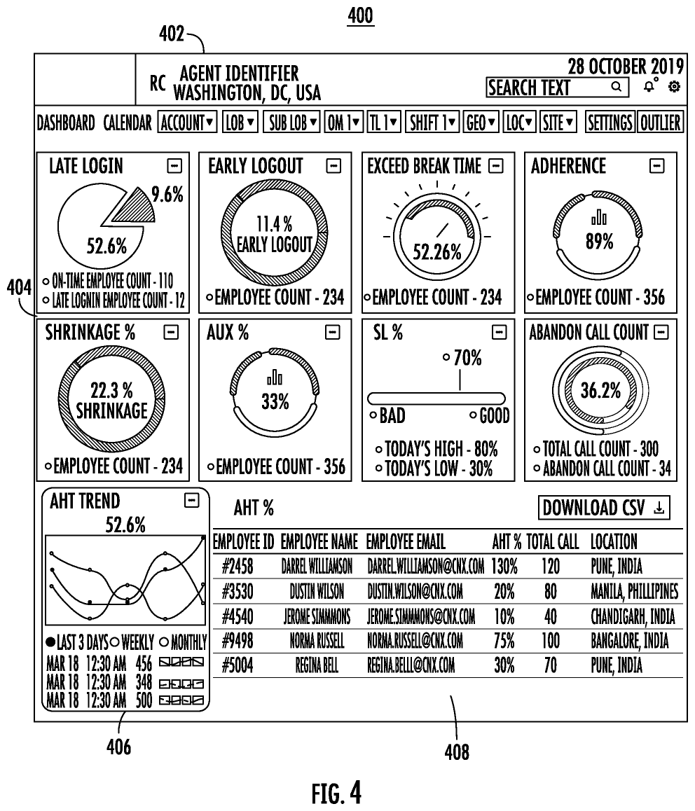

FIG. 4 depicts an illustration of an example metrics dashboard 400 according to example embodiments of the present disclosure. Similarly to FIG. 3, FIG. 4 can depict a metrics dashboard 400 with a plurality of metric representations and values. In particular, FIG. 4 can include an agent profile identifier 402, a plurality of metric graphical elements 404, trend data 406, and a log table 408. The different user interface elements can enable an agent and/or a supervisor to understand the efficiencies and deficiencies in a particular communication session, a particular workday, and/or a particular aggregated period of time. The user interface can look the same for the agents and the supervisors. Alternatively and/or additionally, the user interface may look different for agents and supervisors.

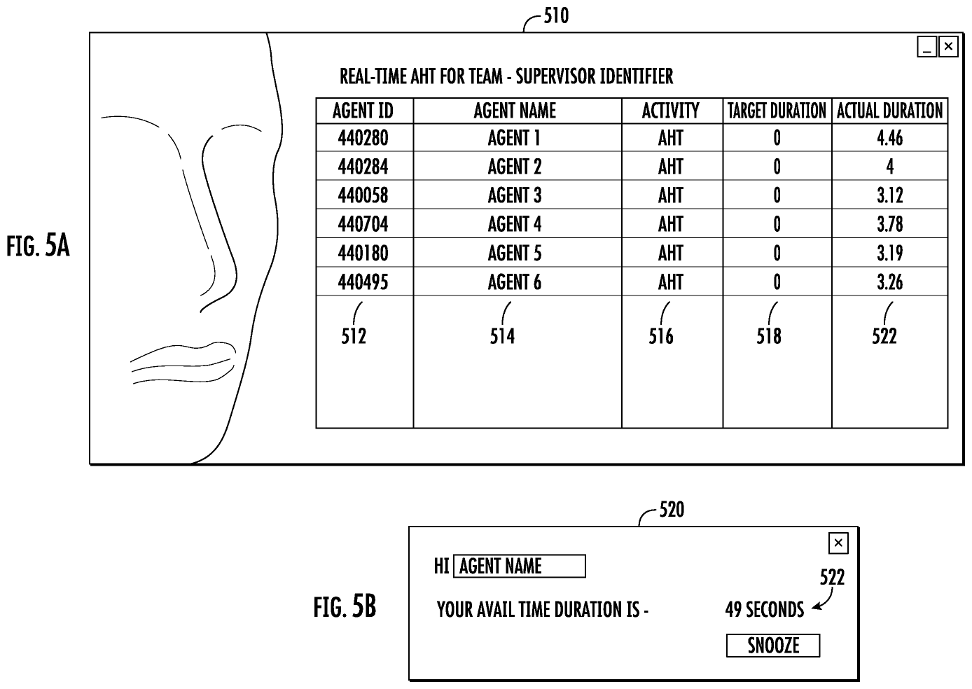

FIGS. 5A-5B depict illustrations of example notifications according to example embodiments of the present disclosure. In particular, FIG. 5A can depict an example report notification 510 for a supervisor. The example report notification 510 can include a list of agents that have trigger events as determined by a threshold time being reached. In some implementations, the report notification 510 can include agent IDs 512, agent names 514, the activity that met the threshold 516, the target for that metric 518, and the actual duration of the occurrence.

FIG. 5B can depict an example agent notification 520. In some implementations, the example agent notification 520 can be provided and/or updated at a pre-determined interval. The agent notification 520 can include the agent's name and the time duration 522 for the particular communication session. In some implementations, the time duration 522 can include an indicator descriptive of the status of the event. For example, the indicator can be a color (e.g., green for under the threshold and red for above the threshold) and/or a symbol (e.g., a checkmark for under the threshold and an “x” for over the threshold).

### Example Methods

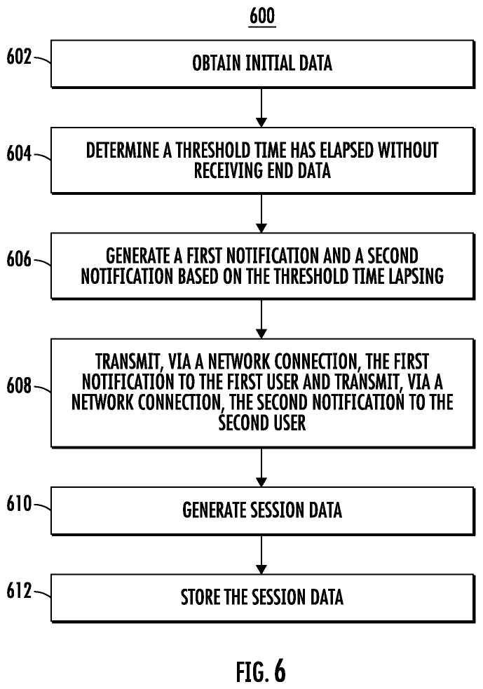

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain initial data. The initial data can be associated with a begin time of a communication session. The communication session can include a first user. The first user can be an agent facilitating one or more communication sessions. The communication sessions can include a phone call, a video call, chat via a user interface, etc.

At 604, the computing system can determine a threshold time has elapsed without receiving end data. The end data can be associated with an end time. In some implementations, the initial data and the end data can be obtained from a remote desktop. For example, a remote desktop can aggregate communication session data from one or more communication services providers. The remote desktop can then be accessed by a server computing system.

At 606, the computing system can generate a first notification and a second notification based on the threshold time lapsing. In some implementations, the first notification can include one or more status indicators. The one or more status indicators can be descriptive of a threshold status for the communication session. The one or more status indicators can include a color indicator (e.g., a green indicator may be descriptive of the communication session being below a threshold time and a red indicator may be descriptive of the communication session elapsing the threshold time).

At 608, the computing system can transmit, via a network connection, the first notification to the first user and transmit, via a network connection, the second notification to the second user. The transmission can occur via a network. In some implementations, the first notification may be provided in an agent user interface. The first notification may be provided as a pop-up display and can include the elapsed time for the communication session. The second user can be a supervisor for the agent. The supervisor can be located in a different location than the first user. In some implementations, the first user and the second user may be communicatively connected via an internet connection. The transmission can occur via the network. In some implementations, the second notification may be provided in a supervisor user interface. The second notification may be provided as a pop-up display and can include the elapsed time for the communication session. The second notification can be provided in a report that lists data associated with a plurality of first users in a plurality of communication sessions.

At 610, the computing system can generate session data. The session data can include information associated with the communication session. In some implementations, the session data can be descriptive of the begin time and the end time of the talk time, the hold time, the wait time, and/or the wrap time.

At 612, the computing system can store the session data. In some implementations, the session data can be stored in a database for retrieval for future reports, for additional metric generation, or for determining new thresholds.

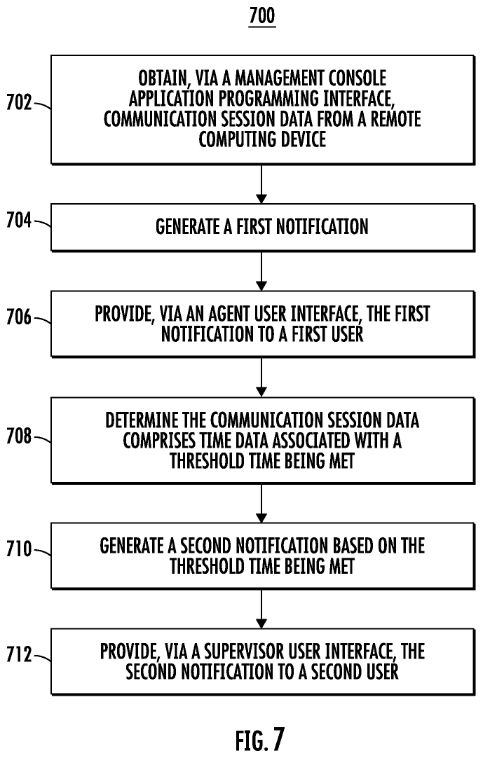

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain, via a management console application programming interface, communication session data from a remote computing device. The remote computing device can be associated with the first user. The remote computing device can be communicatively connected to a phone device.

The communication session data can include an elapsed communication time descriptive of overall length of time of a communication session, a hold time descriptive of overall length of time of a third user being put on hold, and a wait time descriptive of overall length of time of a fourth user being put on hold. In some implementations, the third user and the fourth user can be the same person. Alternatively and/or additionally, the third user and the fourth user can be different people.

At 704, the computing system can generate a first notification. The first notification can be descriptive of at least a portion of the communication session data. The first notification can include the overall length of time, the hold time, and/or the wait time.

At 706, the computing system can provide, via an agent user interface, the first notification to a first user. The first notification can be provided via a pop-up graphical element in the agent user interface. Alternatively and/or additionally, the first notification may be provided via a widget and/or gadget in the agent user interface.

At 708, the computing system can determine the communication session data comprises time data associated with a threshold time being met. The threshold time can be set manually or via automatic determination (e.g., the threshold time can be determined based at least in part on aggregated data from a plurality of past communication sessions). For example, in some implementations, the standard deviation for communication session times can be determined. The standard deviation can then be utilized to determine an appropriate threshold time for flagging irregular events.

At 710, the computing system can generate a second notification based on the threshold time being met. The second notification can include session information. The session information can include first user data and at least a portion of the communication session data. In some implementations, the first user data can be associated with the first user.

At 712, the computing system can provide, via a supervisor user interface, the second notification to a second user. In some implementations, the first user and the second user can be in different locations. For example, the first user can be an agent that is remotely working, and the second user can be a supervisor located in their own respective remote location.

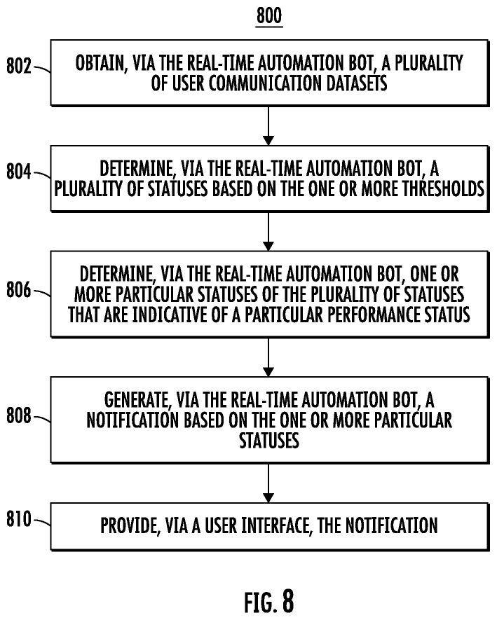

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain, via the real-time automation bot, a plurality of user communication datasets. The plurality of user communication datasets can be associated with a plurality of respective remote users. Additionally and/or alternatively, the plurality of user communication datasets can be associated with a plurality of respective communication sessions.

Obtaining, via the real-time automation bot, the plurality of user communication datasets can include accessing a remote desktop, identifying data for collection, and obtaining the data for collection. In some implementations, in response to obtaining the data for collection, the real-time automation bot can delete the data for collection from the remote desktop.

At 804, the computing system can determine, via the real-time automation bot, a plurality of statuses based on one or more thresholds. The plurality of statuses can be associated with the plurality of user communication datasets. In some implementations, each status can be associated with a different respective communication session.

At 806, the computing system can determine, via the real-time automation bot, one or more particular statuses of the plurality of statuses that are indicative of a particular performance status. The particular performance status can include a poor performance status as determined by comparing an elapsed time associated with a respective user communication dataset.

At 808, the computing system can generate, via the real-time automation bot, a notification based on the one or more particular statuses. The notification can be descriptive of one or more particular user communication datasets. Additionally and/or alternatively, the one or more particular user communication datasets can be associated with the one or more particular statuses.

At 810, the computing system can provide, via a user interface, the notification. For example, the systems and methods can generate a pop-up interface element descriptive of the notification and can provide the pop-up interface element in the user interface. Alternatively and/or additionally, the systems and methods can generate a supervisor report descriptive of the notification and can provide the supervisor report in the user interface.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for automated tracking of communication sessions for remote users, the computing system comprising:
one or more processors; and
one or more non-transitory computer-readable media that collectively store instructions that, when executed by the one or more processors, cause the computing system to perform operations, the operations comprising:
obtaining initial data, wherein the initial data is associated with a begin time of a communication session, wherein the communication session comprises a first user;
determining a threshold time has elapsed without receiving end data, wherein the end data is associated with an end time;
generating a first notification and a second notification based on the threshold time lapsing, wherein the first notification comprises one or more status indicators;
transmitting, via a network connection, the first notification to the first user;
transmitting, via the network connection, the second notification to a second user;
generating session data, wherein the session data comprises information associated with the communication session; and
storing the session data.

2. The computing system of claim 1, wherein the operations further comprise:
obtaining second initial data, wherein the second initial data is associated with a second begin time associated with a second communication session, wherein the second communication session comprises a third user;
determining the threshold time has elapsed without receiving second end data, wherein the second end data is associated with a second end time associated with the second communication session; and
wherein the second notification comprises data associated with the communication session and the second communication session.

3. The computing system of claim 1, wherein the operations further comprise:
obtaining hold data, wherein the hold data is descriptive of a hold time associated with the first user;
determining the hold time is greater than a hold time threshold;
generating a third notification and a fourth notification;
transmitting via the network connection, the third notification to the first user; and
transmitting, via the network connection, the fourth notification to the second user.

4. The computing system of claim 1, wherein the initial data and the end data are obtained from a remote desktop.

5. The computing system of claim 1, wherein the one or more status indicators are descriptive of a threshold status for the communication session.

6. A computer-implemented method for real-time tracking and notification transmission, the method comprising:
obtaining, via a management console application programming interface and by a computing system comprising one or more processors, communication session data from a remote computing device;
generating, by the computing system, a first notification, wherein the first notification is descriptive of at least a portion of the communication session data;
providing, via an agent user interface and by the computing system, the first notification to a first user;
determining, by the computing system, the communication session data comprises time data associated with a threshold time being met;
generating, by the computing system, a second notification based on the threshold time being met, wherein the second notification comprises session information, wherein the session information comprises first user data and at least a portion of the communication session data, wherein the first user data is associated with the first user; and
providing, via a supervisor user interface and by the computing system, the second notification to a second user.

7. The computer-implemented method of claim 6, wherein the first user and the second user are in different locations.

8. The computer-implemented method of claim 6, wherein the remote computing device is associated with the first user.

9. The computer-implemented method of claim 6, wherein the communication session data comprises:
an elapsed communication time descriptive of overall length of time of a communication session;
a hold time descriptive of overall length of time of a third user being put on hold; and
a wait time descriptive of overall length of time of a fourth user being put on hold.

10. A computing system, the computing system comprising:
one or more processors;
a real-time automation bot, wherein the real-time automation bot is configured to continuously and automatically obtain time data associated with one or more communication events, and wherein the real-time automation bot is configured to generate one or more notifications based on the time data; and
one or more non-transitory computer-readable media that collectively store instructions that, when executed by the one or more processors, cause the computing system to perform operations, the operations comprising:
obtaining, via the real-time automation bot, a plurality of user communication datasets, wherein the plurality of user communication datasets are associated with a plurality of respective remote users;
determining, via the real-time automation bot, a plurality of statuses based on one or more thresholds, wherein the plurality of statuses are associated with the plurality of user communication datasets;
determining, via the real-time automation bot, one or more particular statuses of the plurality of statuses that are indicative of a particular performance status;
generating, via the real-time automation bot, a notification based on the one or more particular statuses; and
providing, via a user interface, the notification.

11. The computing system of claim 10, wherein the particular performance status comprises a poor performance status as determined by comparing an elapsed time associated with a respective user communication dataset.

12. The computing system of claim 10, wherein the notification is descriptive of one or more particular user communication datasets, wherein the one or more particular user communication datasets associated with the one or more particular statuses.

13. The computing system of claim 10, wherein providing, via the user interface, the notification comprises:
generating a pop-up interface element descriptive of the notification; and
providing the pop-up interface element in the user interface.

14. The computing system of claim 10, wherein providing, via the user interface, the notification comprises:
generating a supervisor report descriptive of the notification; and
providing the supervisor report in the user interface.

15. The computing system of claim 10, wherein obtaining, via the real-time automation bot, the plurality of user communication datasets comprises:
accessing, via the real-time automation bot, a remote desktop;
identifying, via the real-time automation bot, data for collection; and
obtaining, via the real-time automation bot, the data for collection.

16. The computing system of claim 15, wherein obtaining, via the real-time automation bot, the plurality of user communication datasets further comprises:
in response to obtaining the data for collection, deleting, via the real-time automation bot, the data for collection from the remote desktop.

17. The computing system of claim 10, wherein the operations further comprise:
obtaining a plurality of user specific datasets associated with the plurality of respective remote users; and
wherein the notification is generated based at least in part on one or more particular user specific datasets of the plurality of user specific datasets.

18. The computing system of claim 17, wherein the one or more particular user specific datasets are associated with the one or more particular statuses.

19. The computing system of claim 17, wherein the operations further comprise:
determining, via the real-time automation bot, a user trigger event occurred based at least in part on the plurality of user specific datasets;
generating, via the real-time automation bot, an additional notification based on the user trigger event; and
providing, via the user interface, the additional notification.

20. The computing system of claim 19, wherein the user trigger event comprises one or more remote users of the plurality of respective remote users logging out of a remote user interface before a preset time.
